(19) United States
(12) Patent Application Publication
(10) Pub. No.: US 2014/0100820 A1
(43) Pub. Date: Apr. 10, 2014

(54) METHOD AND DEVICE TO EVALUATE GLOSS LEVEL

(71) Applicants: Takuroh Sone, Kanagawa (JP); Makoto Hino, Kanagawa (JP)

(72) Inventors: Takuroh Sone, Kanagawa (JP); Makoto Hino, Kanagawa (JP)

(21) Appl. No.: 14/025,072

(22) Filed: Sep. 12, 2013

(30) Foreign Application Priority Data
Oct. 9, 2012 (JP) 2012-224414

(51) Int. Cl. G01N 21/57

(52) U.S. Cl. CPC G01N 21/57
USPC 702/189

(57) ABSTRACT

A method of evaluating gloss level based on a specular gloss level of an object measured by a gross meter includes calculating a gloss rating by a function that uses a ratio between 20-degree specular gloss and 60-degree specular gloss as a variable and draws a saturation curve, and calculating an image clarity rating by a quadric or higher dimensional function that uses, as a variable, a difference calculated by deducting a weighted 60-degree specular gloss from a weighted 20-degree specular gloss.

### CROSS-REFERENCE TO RELATED APPLICATION

This patent application is based on and claims priority pursuant to 35 U.S.C. §119 to Japanese Patent Application No. 2012-224414, filed on Oct. 9, 2012, in the Japan Patent Office, the entire disclosure of which is hereby incorporated by reference herein.

### BACKGROUND OF THE INVENTION

1. Technical Field

The present invention generally relates to a method and a device to evaluate gloss level and image clarity of an object, and, more particularly to, a method and a device to evaluate gloss level and image clarity of an image produced by, for example, inkjet printing, offset printing, electrophotography, silver-salt photography, or sublimation printing; and a coated sample coated with, for example, ultraviolet (UV) coating.

2. Description of the Background Art

Currently, demands for high-value-added images are increasing. In particular, gloss level and image clarity are important image quality characteristics.

The term “gloss level” used here means the amplitude of perceived gloss or degree of shine of images. The term “image clarity” used here means the degree of perceived clarity (or sharpness) of an image of a light source, such as fluorescent, reflected from the object.

There are differences between the gloss level and the image clarity visually perceived by human beings and those measured mechanically. If the differences are reduced and digitized or converted into numerical form, image quality characteristics can be made uniform, and thus high-value-added images can be provided. The differences converted into numeric form can be used in quality inspection.

Gloss level and image clarity can be measured using various methods, such as those listed below.

1: JIS (Japanese Industrial Standards) Z 8741 Specular glossiness, Method of measurement;

2: JIS K 7374 Plastics, Determination of image clarity;

3: A method disclosed in JP-2005-274340-A;

4: A method disclosed in JP-2007-278949-A;

5: A method disclosed in JP-2007-33099-A; and

6: A method disclosed in JP-2011-169706-A

In method 1, a light-receiving device is disposed in a direction of specular reflection (regular reflection) of an object, and the intensity of gloss is digitized using the pencils of reflected light measured at a specified acceptance angle (receiving opening angle) and the pencils of light reflected from a reference sample. In this method, the angle of incidence and the angle of reflection are specified at 20 degrees, 60 degrees, 75 degrees, and 85 degrees. The acceptance angle depends on the angle.

In method 2, an optical comb perpendicular to a ray axis of light transmitted through an object or light reflected from a sample is moved, and the amount of light (M) when a transmission portion of the optical comb is positioned at the ray axis, and the amount of light (m) when a shading portion thereof is positioned at the ray axis are acquired. Further, the ratio of the difference (M−m) between the two to the sum (M+m) of the two is regarded as the image clarity rating.

Method 3 aims at solving the inconvenience that the measured value according to method 1 differs from the gloss level visually perceived. In this method, the visually perceived gloss level is digitized using an evaluation formula in which the intensity of reflected light measured by a variable angle photometer and the image clarity measured according to method 2 are variables.

Method 4 aims at solving the inconvenience that the correlation between the measurement according to method 1 and visually perceived gloss level is low, similarly to method 3.

Although only the intensity of specular reflection light is measured in the method of measuring specular surface glossiness, the gloss level perceived by human beings is based on, in addition to specular reflection light, characteristics of spatial light distribution close to specular reflection.

Therefore, the correlation between the objective evaluation according to the specular surface glossiness measurement and the subjective perception is degraded if recording media to be evaluated includes both a sample that creates a wider distribution of reflected light close to specular reflection and a sample that creates a narrower distribution of reflected light close to the specular reflection.

That is, in typical measurement methods, measurements of physical elements are not sufficient for evaluating gloss level.

In view of the foregoing, the distribution of reflected light may be measured while the angle is varied, and, based on the distribution of intensity of reflected light, various characteristics, such as the distribution width of reflected light, the maximum increase rate and maximum reduction rate at primary differentiation, the intensity of reflected light close to the specular reflection light may be used as gloss level indexes.

Method 5 (JP-2007-033099-A) includes calculation of the ratio and difference of multiple signals when the specular reflection light is received with the acceptance angle varied. Either or both of the ratio and the difference are used for evaluating the image clarity and gloss level unevenness.

Method 6 (JP-2011-169706-A) concerns evaluation of gloss level uniformity in an entire image. Using an evaluation chart in which the amount of toner adhering is changed stepwise, the 60-degree specular gloss of each batch in the chart is measured. Based on the difference between an ideal value and a measurement value of 60-degree specular gloss relative to lightness, a rating of gloss uniformity in an entire image is calculated.

The inventors of the present invention recognize that there are following difficulties in the above-described methods.

As discussed in methods 3 and 4, the correlation between the measurements according to method 1 with the gloss level perceived visually may be lower.

Although method 2 concerns measurements of image clarity of objects, intended objects are plastics basically. Therefore, the correlation between the measurements according to method 2 and the subjective image clarity may be low when the objects are images produced by various image forming methods.

Additionally, commercial evaluation devices that adopt JIS K 7374 method to evaluate image clarity require trimming of samples to be set in the device and are not intended to evaluate samples produced by image forming apparatuses as they are.

In method 3 (JP-2005-274340-A), a gloss rating is calculated using a variable-angle photometer and an image clarity measuring device. When two or more measuring devices are required, it can take time to compute the rating. Further, as described above, trimming of samples is required when variable-angle photometers and image clarity measuring devices that are available commercially are used.

Further, although six black solid images produced by two different methods, namely, inkjet printing and silver-salt photography, are used as samples to check the accuracy, the sample number and the sample types may be insufficient for confirming the accuracy.

Further, although the correlation with the subjective evaluation score in one-to-five scale is checked, it seems that the scale is not standardized. It is unclear whether it is correlated with the distance of the perceived evaluation value.

In method 4, although an index value is calculated based on the characteristic value according to the measured distribution of reflected light, the measurement time can be significantly long since the angle of the light-receiving device is changed in the measurement of the distribution of reflected light. Although many examples of the characteristic value are given, which is the best is not specified.

Regarding the evaluation accuracy, the correlation with the subjective evaluation score is not checked. Regarding the measurement time, an example in which two light-receiving devices, one for specular reflection light and the other for light adjacent to specular reflection, are used is proposed.

Although the measurement time may be reduced using the above-described method, an optimum method to calculate the rating is not specified, and correspondence with subjective evaluation is not confirmed.

The image clarity rating and the gloss unevenness rating in method 5 are the ratio of the measurement values at different acceptance angles or the difference as is. In the evaluation of image clarity, the contribution rate regarding the subjective evaluation score is 0.83, which is not very high. The sample types in method 5 are inkjet printing and silver-salt photography, but the sample color is not specified. Evaluation of different color samples and samples produced by electrophotography and sublimation printing is not described.

The method 6 concerns evaluation of gloss level uniformity in an entire image, but does not evaluate the gloss level and the image clarity in a given image area.

### SUMMARY OF THE INVENTION

In view of the foregoing, one embodiment of the present invention provides a method of evaluating gloss level based on a specular gloss level of an object calculated by a gloss meter. The method includes a step of calculating a gloss rating with a processor and a step of calculating an image clarity rating with a processor. The gloss rating is calculated using a function that uses a ratio between 20-degree specular gloss and 60-degree specular gloss as a variable and draws a saturation curve. The image clarity rating is calculated using a quadric or higher dimensional function that uses, as a variable, a difference calculated by deducting a weighted 60-degree specular gloss from a weighted 20-degree specular gloss.

Another embodiment provides a gloss evaluation device to evaluate gloss level based on a specular gloss level of an object according to the above-described method. The gloss evaluation device includes a gloss meter to measure 20-degree specular gloss and 60-degree specular gloss, a storage device to store the 20-degree specular gloss and the 60-degree specular gloss measured by the gloss meter, and a processor to calculate a gloss rating and an image clarity rating using the 20-degree specular gloss and the 60-degree specular gloss stored in the storage device.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram that illustrates a method of subjective evaluation experiment in a gloss evaluation method according to a first embodiment;

FIG. 2 is a graph illustrating the correlation between perceived gloss level and calculated ratings;

FIG. 3 is a graph illustrating the correlation between perceived image clarity and calculated ratings;

FIG. 4 is a graph illustrating the correlation between relative luminous intensity and reflection angle, and a solid line and broken lines represent the luminous intensity and a change rate, respectively;

FIG. 5 is a graph illustrating the relation between a width of the reflected light distribution and subjective scores;

FIG. 6 is a graph illustrating the relation between a maximum change rate and the subjective scores;

FIG. 7 is a diagram illustrating a practical range in which a gloss meter receives light, and an abscissa and an ordinate represent the reflection angle and the luminous intensity, respectively;

FIG. 8 is a block diagram illustrating a configuration of a gloss evaluation device according to a third embodiment;

FIG. 9 is a schematic diagram illustrating a variation of a processor; and

FIG. 10 is a schematic diagram illustrating a system that includes the gloss evaluation device and an image forming apparatus.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, evaluation of gloss level and image clarity of samples is described.

### First Embodiment

(Gloss Level Measurement Method)

According to JIS Z 8741, 20-degree specular gloss and 60-degree specular gloss (hereinafter also simply “specular gloss G20” and “specular gloss G60”) of samples are measured.

For example, a specular gloss meter, GM-26D, manufactured by Murakami Color Research Laboratory, can be used.

However, the manufacture is not limited as long as the gloss level is measured according to JIS Z 8741.

(Calculation of Gloss Rating)

Using the measured specular gloss G20 and the measured specular gloss G60, a gloss rating (i.e., gloss evaluation value) and an image clarity rating (i.e., image clarity evaluation value) are calculated.

The gloss rating can be expressed by formula 1 below.

a1×exp(a2×G20/G60)+a3 Formula 1

The image clarity rating can be expressed by formula 2 below.

b1×(G20−b2×G60)²+b3×(G20−b4×G60)+b5 Formula 2

In formulas 1 and 2, G20 and G60 represent 20-degree and 60-degree specular gloss values, and a1, a2, a3, and b1 through b5 are parameters. In image clarity evaluation, however, the image clarity is deemed unrecognizable when the 60-degree specular gloss is lower than 40% (G60<40%).

The calculated gloss rating is obtained using a function that uses the ratio of the specular gloss G20 to the specular gloss G60 as a variable and is an exponential function with the bottom “e” such that the function draws a saturation curve.

The image clarity rating is obtained using a quadric that uses, as a variable, the difference calculated by deducting, from the specular gloss G20, the specular gloss G60 modified by weights of the parameters b2 and b4.

However, the image clarity is deemed unrecognizable when the specular gloss G60 is lower than 40% (G60<40%).

When a sample with the specular gloss G60 lower than 40% was evaluated subjectively regarding the image clarity, the reflected light image was significantly unclear, and the subjective score of image clarity was constantly close to the lowest value. Accordingly, it is deemed that the image clarity is unrecognizable in such cases.

Using the subjective score of gloss level and image clarity, each parameter of the formulas is obtained by nonlinear regression.

In the present embodiment, the correlation with the subjective score is high when the parameter a2 for the gloss rating is in a range of −3.0≦a2≦−2.0, and when the parameters b2 and b4 for image clarity rating are in the relation of 1.2≦b4≦b2≦1.5.

As described above, according to the present embodiment, gloss level can be evaluated using commercial measuring devices, thus obviating the necessity of developing a special device for the evaluation. Accordingly, the cost does not increase.

Additionally, the measurement values used in formulas 1 and are specular gloss G20 and G60 only. Therefore, the measurement time can be shortened, and computation load can be smaller.

(Accuracy Confirmation)

Confirmation of accuracy of the above-described evaluation is described below.

To obtain the subjective scores, the samples are evaluated subjectively as follows.

Preliminarily provide examinees with scale samples in which the gloss level and the image clarity vary stepwise, and present the samples one by one, at random, to examinees. The examinees judge the level and degree of each sample referring to the scale samples.

Initially prepare the scale samples for the above-described subjective evaluation of gloss level and image clarity.

For the scale samples, use seven sample images produced by silver-salt photography, inkjet printing, electrophotography, and sublimation printing.

Evaluation test conditions are shown in Table 1.

TABLE 1

| | SILVER-SALT PHOTOGRAPHY, INKJET |
|---|---|
| | PRINTING, ELECTROPHOTOGRAPHY, |
| SAMPLE TYPE | AND SUBLIMATION PRINTING |
| NUMBER OF GLOSS | 7 |
| LEVEL SAMPLE | |
| NUMBER OF IMAGE | 7 |
| CLARITY SAMPLE | |
| SIZE OF SAMPLE | IMAGE AREA (mm): 40 × 50 |
| | MARGIN (mm): 10-20 |
| NUMBER OF EXAMINEE | 14 |
| COLOR OF SAMPLE | BLACK SOLID |
| OBSERVATION | 350 mm |
| DISTANCE | |
| LIGHT | D50 LIGHT SOURCE, 1200 1X |

Using Nakaya variation of Scheffe's pairwise comparison, evaluate the gloss level and the image clarity on one-to-five scale.

Allow the examinees to pick and look the samples at different angles freely and instruct them to evaluate “strength of perceived gloss” for gloss level and “sharpness of light reflected on the surface of the sample” for image clarity.

Using correspondence analysis (quantification method type III), the data obtained is scaled into the subjective scores.

The experimentally obtained specular gloss level, the subjective score of gloss, and the subjective score of image clarity are shown in Tables 2 and 3.

TABLE 2

| SAMPLE | G20 (%) | G60 (%) | SUBJECTIVE GLOSS SCORE |
|---|---|---|---|
| A | 86.3 | 94.7 | 0.925 |
| B | 79.8 | 94.8 | 0.740 |
| C | 22.1 | 43.8 | 0.350 |
| D | 28.2 | 60.1 | 0.332 |
| E | 14.3 | 61.1 | −0.375 |
| F | 5.1 | 32.9 | −0.881 |
| G | 1.1 | 15.1 | −1.112 |

TABLE 3

| | | | SUBJECTIVE IMAGE CLARITY |
|---|---|---|---|
| SAMPLE | G20 (%) | G60 (%) | SCORE |
| H | 84.7 | 93.5 | 1.100 |
| I | 78.8 | 94.4 | 0.709 |
| J | 74.4 | 95.9 | 0.243 |
| K | 21.7 | 43.1 | −0.109 |
| L | 65.2 | 93.3 | 0.125 |
| M | 16.7 | 45.7 | −0.768 |
| N | 17.3 | 50.8 | −1.112 |

The specular gloss meter, GM-26D, manufactured by Murakami Color Research Laboratory, was used to measure the specular gloss G20 and the specular gloss G60.

The specular gloss was measured twice for each sample, and the mean value was used.

Thus, the scale samples and the quantitative subjective scores were obtained.

Next, using the scale samples thus obtained, execute subjective evaluation tests.

In addition to the sample types listed in Table 1, offset printing images and electrophotographic images with gloss treatment, such as cooling separation, ultraviolet (UV) coating, or the like, were added.

The samples were solid images of cyan (C), magenta (M), yellow (Y), red (R), green (G), and blue (B); white sheets without coloring matters; and red halftone (HT) images.

The number of gloss evaluation samples was 47, and the range of the specular gloss G60 thereof was 15% to 100%. The number of image clarity evaluation samples was 37, and the range of the specular gloss G60 thereof was 40% to 100%.

The characteristics of the samples are listed in Table 4.

TABLE 4

| | SILVER-SALT PHOTOGRAPHY, INKJET |
|---|---|
| | PRINTING, ELECTROPHOTOGRAPHY, |
| | SUBLIMATION PRINTING AND OFF- |
| SAMPLE TYPE | SET PRINTING |
| NUMBER OF GLOSS | 47 |
| LEVEL SAMPLE | |
| NUMBER OF IMAGE | 37 |
| CLARITY SAMPLE | |
| SIZE OF SAMPLE | IMAGE AREA (mm): 40 × 50 |
| | MARGIN (mm): 10-20 |
| NUMBER OF EXAMINEE | 14 |
| COLOR OF SAMPLE | C, M, Y, R, G, AND B SOLID IMAGES; |
| | WHITE (PAPER SHEET); AND RED |
| | HALFTONE IMAGE |
| OBSERVATION | 350 mm |
| DISTANCE | |
| LIGHT | D50 LIGHT SOURCE, 1200 1X |

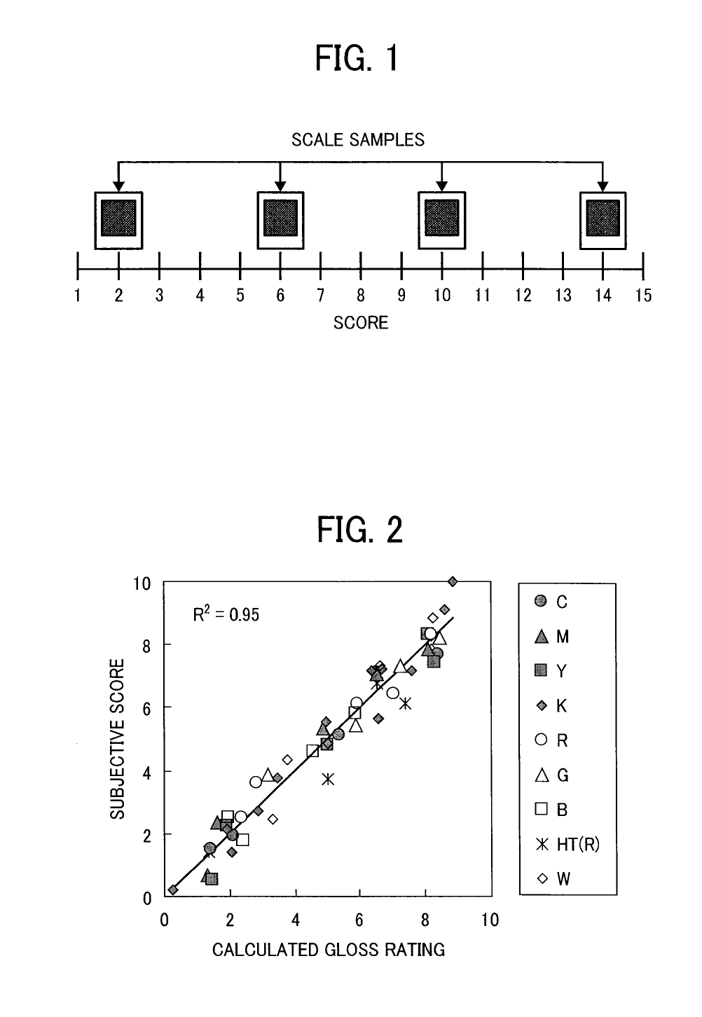

FIG. 1 illustrates the method of subjective evaluation.

Extract four black solid images from those in Tables 2 and 3, scaled according to pairwise comparison as the scale samples, and dispose these scale samples at the points of 2, 6, 10, and 14 in ascending order of subjective scores. Present the samples one by one to the examinees at random and request the examinees to score the gloss level thereof from 1 to 15.

Convert the score of each sample into evaluation scale according to pairwise comparison, and use the mean value of the score of each sample as the subjective score of that sample. Thus, quantitative ratings are available.

The subjective evaluation of image clarity was executed similarly.

The subjective score was standardized so that the score of the sample deemed the best is 10.

Next, measure the specular gloss and calculate the rating using formulas 1 and 2 described above. The gloss rating was calculated using formula 1. The parameters a1 through a3 were determined using nonlinear regression with the subjective score serving as a target variable.

FIG. 2 illustrates the correlation between the perceived gloss level and the calculated rating. The contribution rate was 0.95, and thus the correlation was very high.

Next, results of image clarity evaluation are described below.

The image clarity rating was calculated using formula 2. The parameters b1 through b5 were determined using nonlinear regression with the subjective score serving as a target variable.

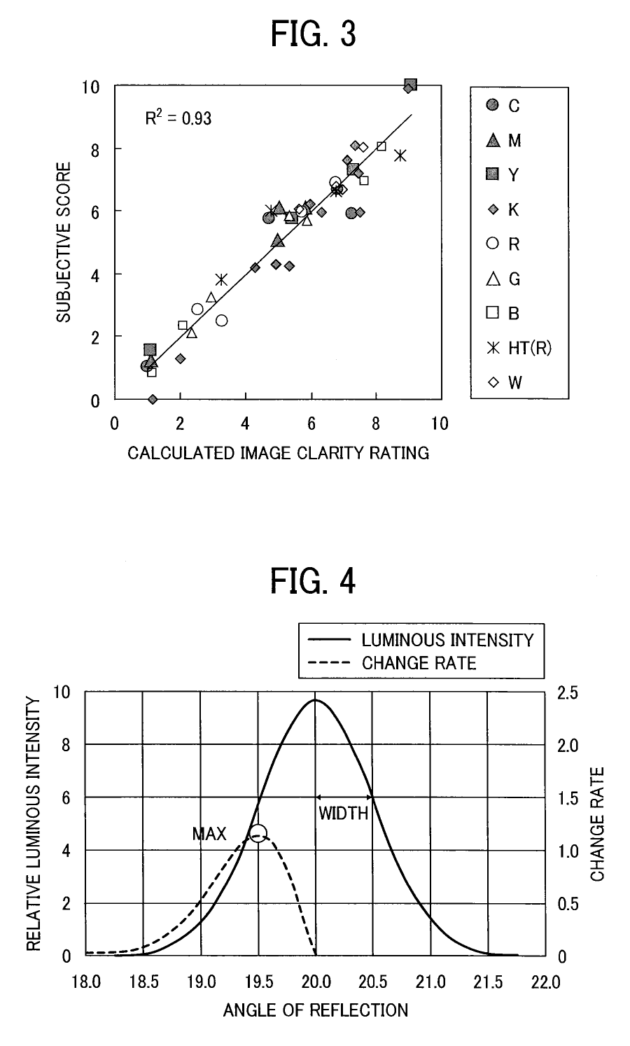

FIG. 3 illustrates the correlation between the image clarity and the rating. The contribution rate was 0.93, and thus the correlation was very high.

Regarding the relation between the calculated rating and the subjective score, it was confirmed that both the calculated gloss rating and the calculated image clarity rating have a contribution rate of 0.9 or higher.

To enhance the accuracy of the evaluation method, the range of sample types and the number of sample colors are increased in the present embodiment.

According to the present embodiment, images of silver-salt photography, inkjet printing, electrophotography (including cooling separation and UV coating), sublimation printing can be evaluated.

Additionally, the colors evaluated include cyan, magenta, yellow, red, green, blue, black, and white. Thus, images of various image forming methods and various colors (including halftone) can be evaluated accurately and quantitatively.

(Evaluation Principles)

Descriptions are given below of principles to evaluate subjective gloss level according to the present embodiment.

To analyze the subjective gloss level (i.e., perceived gloss level), the distribution of light reflected on the samples listed in Tables 2 and 3 was measured using a variable angle photometer.

Characteristics highly correlated with the subjective gloss level were extracted from the reflected light distribution. It can be recognized that the perceived gloss level is highly correlated with the logarithm of the width of the reflected light distribution and that the image clarity is highly correlated with the logarithm of the maximum change rate.

The term “width of the reflected light distribution” used here means standard deviation σ obtained when the distribution data of reflected light intensity corresponding to the angle of measurement by the variable angle photometer is fitted with Gaussian function.

The term “maximum change rate” used here means the maximum value of the value obtained when the fitted data is differentiated by angle.

FIG. 4 is a conceptual diagram thereof. In FIG. 4, “MAX” represents the maximum change rate.

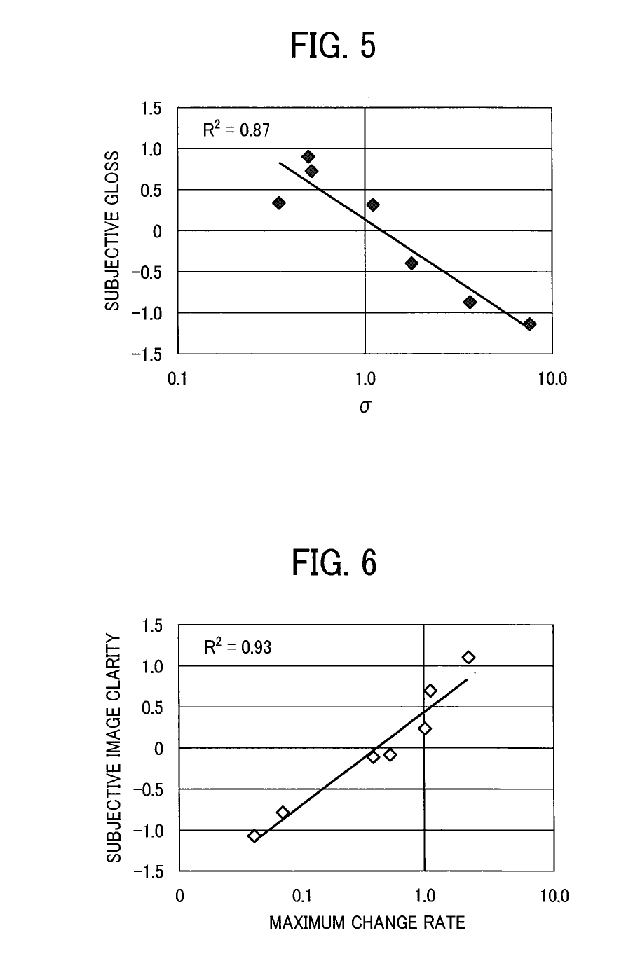

FIG. 5 illustrates the relation between the width of the reflected light distribution (σ) and the subjective score. FIG. 6 illustrates the relation between the maximum change rate and the subjective score.

Based on the results above, descriptions are given below of why the correlation can be high.

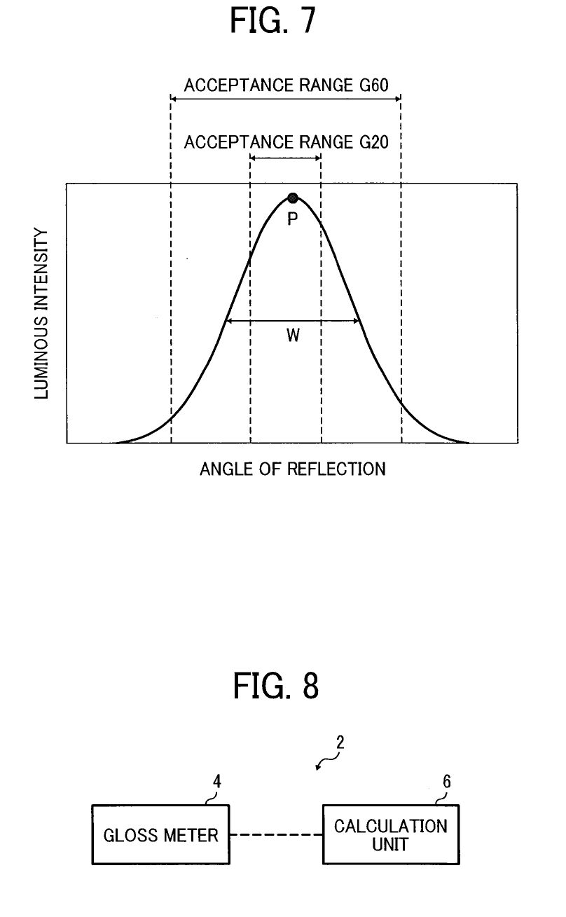

FIG. 7 is a conceptual diagram of the distribution of reflected light when collimated light is applied to the samples. In FIG. 7, reference character P represents the peak amount of light, and W represents the width of reflected light distribution.

As specified in JIS K 8741, the size of aperture to receive light is different between the specular gloss G20 and the specular gloss G60.

Since the range of light received is adjacent to the distribution of specular reflection in the case of the specular gloss G20, it can be approximated to the peak amount of light. By contrast, since the range of light received includes lower portions of the distribution of specular reflection in the case of the specular gloss G60, it depends on the peak and the broadening of reflected light.

Accordingly, regarding the ratio of specular gloss G60/G20, the amount corresponding to the broadening of reflected light is calculated by standardizing the specular gloss G60 with the specular gloss G20 corresponding to the peak amount of light.

In other words, the ratio of G60 to G20 corresponds to the amplitude of broadening of the reflected light distribution.

It can be known from the description above that the perceived gloss level is correlated with the width of the reflected light distribution. As can be known from the results shown in FIG. 5, however, the amount perceived by human beings is logarithmic to the amount of stimulus. That is, the amount of perception (sensation) may become close to the saturation relative to the amount of stimulus. Accordingly, the width of the reflected light distribution does not have a linear correlation with the subjective score.

Therefore, formula 1 described above is an exponential function using the ratio as a variable. Thus, this evaluation formula can attain a higher degree of correlation with the subjective score. As long as the function draws a saturation curve, logarithm function, sigmoid function, inverse tangent may be used.

Next, the image clarity is described below.

The maximum change rate increases as the amount of light adjacent to the peak of reflected light distribution increases and the amount of light in the lower portion decreases.

The amount of light in the lower portion corresponds to the difference between the specular gloss G60 and the specular gloss G20. In other words, as the specular gloss G20 increases, and the difference between the specular gloss G60 and the specular gloss G20 decreases, the change rage increases.

In view of the foregoing, the variable used in formula 2 is a value obtained by deducting the weighted specular gloss G60 from the specular gloss G20.

Since a simple linear expression fails to correspond to the subjective score, formula 2 is quadratic.

The acceptance range of practical gloss meters is not one-dimensional as shown in FIG. 7 but two-dimensional. Accordingly, the subjective score does not correspond to a linear expression using, as a variable, a value obtained by deducting the weighted specular gloss G60 from the specular gloss G20. Therefore, the difference in dimension is adjusted using the quadratic expression.

### Second Embodiment

The present embodiment is characterized in that formula 3 below is used to calculate the calculated image clarity rating described in the first embodiment.

The calculated image clarity rating can be expressed by the following formula.

c1×(G20−c2×G60)²+c3×(G20−c2×G60)+c4×G20/G60+c5 Formula 3

In formula 3, c1 through c5 represent parameters determined using nonlinear regression with the subjective score serving as a target variable.

In the present embodiment, when the parameter c2 is in a range of 1.2≦c2≦1.5, the calculated image clarity rating was highly correlated with subjective evaluation. When the correlation with the subjective score was checked using the samples described in the first embodiment, the contribution rate was 0.93 and thus high.

Formula 3 uses an identical coefficient of specular gloss G60 in (G20−c2×G60)² and (G20−c2×G60) and includes G20/G60 calculated to obtain the perceived calculated gloss rating. Accordingly, computation load of formula 3 can be lower than that of formula 2.

As described above, the methods according to the above-described embodiments to evaluate perceived gloss level and image clarity are advantageous in that:

the measurement time can be shorter since only specular gloss G20 and specular gloss G60 are measured;

evaluation can be made using values measured by commercial gloss meters;

the number of sample types is greater; the number of colors evaluated is greater; and

the correlation with subjective score is higher.

### Third Embodiment

The present embodiment provides a gloss evaluation device that employs the above-described evaluation methods.

FIG. 8 is a schematic diagram illustrating the gloss evaluation device according to the present embodiment.

A gloss evaluation device 2 shown in FIG. 8 includes a specular gloss meter 4 (also simply “gloss meter 4”) to measure images to be evaluated and a calculation unit 6 to calculate the perceived calculated gloss rating and the calculated image clarity rating.

The specular gloss meter 4 can be a gloss member to measure 20-degree specular gloss and 60-degree specular gloss of images evaluated. The calculation unit 6 can be processors such as computers. Typical gloss meters include an interface with, for example, computers, to exchange measurement data.

The measurement data by the specular gloss meter 4 is stored in a storage device of the computer, and the evaluation value is calculated using the stored data by the above-described formula. In this case, the computer can serve as a storage device to store the gloss level.

Additionally, the measurement data can be stored in a versatile data format in the storage area such as a hard disc. The measurement data thus stored can be transmitted via various communication means, such as a network, to computers, for example.

It is not necessary that the specular gloss meter 4 be connected electrically to the computer. For example, the specular gloss meter 4 is capable of storing the measurement data, and the stored data may be transferred to an external memory device and further to the computer.

In this configuration, since the measurement data can be retrieved using an existing gloss meter, the calculated gloss rating can be generated by a processor (calculation unit) to calculate the rating from the measurement data.

The data processor can be constructed of software or the like. The measurement and the calculation are similar to those according to the above-described embodiments, and thus descriptions thereof are omitted.

In the present embodiment, since the gloss evaluation device can calculate the rating, the calculation can be made automatically or mechanically not manually. Accordingly, even if the amount of measurement data is large, the evaluation results can be available instantaneously.

It is to be noted that, although the description concerns the configuration in which the gloss meter and the processor are independent from each other, alternatively, the memory storage to store the measured gloss level and the processor may be provided inside a gloss meter, thus forming an integrated gloss evaluation device.

Yet alternatively, the calculation unit 6 may be a controller of an image forming apparatus.

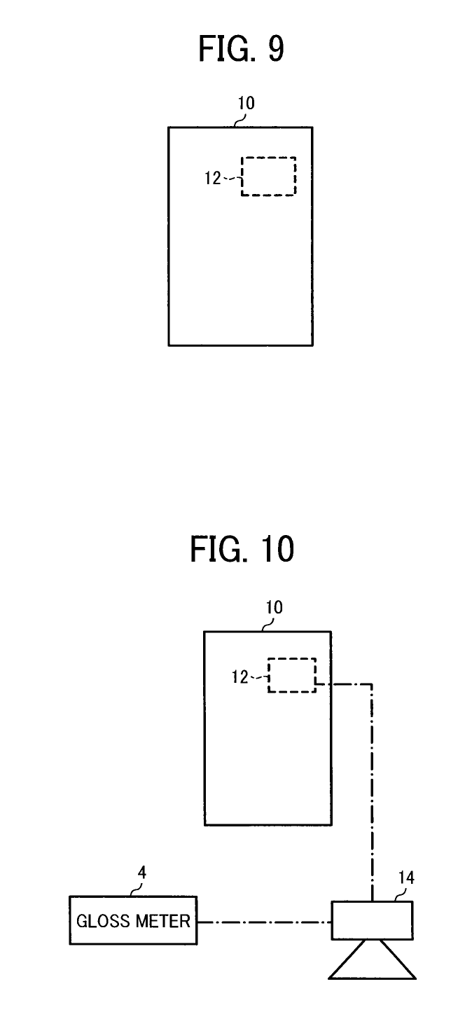

FIG. 9 illustrates an image forming apparatus 10 including a controller 12. For example, as shown in FIG. 9, programs to execute the calculation of the gloss rating according to formula 1, 2, or 3 can be stored in a storage unit of the controller 12.

The above-described programs may be stored in a recording medium such as compact disc-recordable (CD-ROM) and retrieved in the image forming apparatus.

When the image forming apparatus 10 has a capability to connect to a network, the above-described program may be downloaded via the network.

As shown in FIG. 10, the specular gloss meter 4, the image forming apparatus 10, and a computer 14 serving as the processor can be operably connected as an integrated system such that image formation executed by the image forming apparatus 10 can be controlled via the computer 14 based on the calculated gloss rating.

According to the above-described embodiments, the gloss level and the image clarity of a wider range of samples can be evaluated with a higher degree of accuracy, the measurement time can be shorter, and gloss evaluation can be simplified.

According to the above-described embodiments, perceived gloss level and image clarity can be evaluated more accurately and in a shorter time period, and the range of objects evaluated can be wider. Accordingly, high-value-added images can be provided reliably.

It is to be noted that elements and/or features of different example embodiments may be combined with each other and/or substituted for each other within the scope of this disclosure and appended claims.

Further, any one of the above-described and other example features of the present invention may be embodied in the form of an apparatus, method, system, computer program and computer program product. For example, the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

Numerous additional modifications and variations are possible in light of the above teachings. It is therefore to be understood that, within the scope of the appended claims, the disclosure of this patent specification may be practiced otherwise than as specifically described herein.

What is claimed is:

1. A method of evaluating gloss level based on a specular gloss level of an object measured by a gross meter, the method comprising:
calculating, with a processor, a gloss rating by a function that uses a ratio between 20-degree specular gloss and 60-degree specular gloss as a variable and draws a saturation curve; and
calculating, with the processor, an image clarity rating by a quadric or higher dimensional function that uses, as a variable, a difference calculated by deducting a weighted 60-degree specular gloss from a weighted 20-degree specular gloss.

2. The method according to claim 1, wherein a calculation formula of the gloss rating is expressed as:
a1×exp(a2×G20/G60)+a3
wherein G20 represents the 20-degree specular gloss, G60 represents the 60-degree specular gloss, and a1, a2, and a3 are parameters.

3. The method according to claim 2, wherein the parameter a2 is within a range from −3.0≦a2≦−2.0.

4. The method according to claim 1, wherein a calculation formula of the image clarity rating is expressed as:
b1×(G20−b2×G60)²+b3×(G20−b4×G60)+b5
wherein G20 represents the 20-degree specular gloss, G60 represents the 60-degree specular gloss, and b1 through b5 are parameters.

5. The method according to claim 4, wherein the parameters b2 and b4 satisfy a relation of 1.2≦b4≦b2≦1.5.

6. The method according to claim 4, wherein the image clarity is deemed unrecognizable when the 60-degree specular gloss is lower than 40%.

7. The method according to claim 1, wherein a calculation formula of the image clarity rating is expressed as:
c1×(G20−c2×G60)²+c3×(G20−c2×G60)+c4×G20/G60+c5
wherein G20 represents the 20-degree specular gloss, G60 represents the 60-degree specular gloss, and c1 through c5 are parameters.

8. The method according to claim 7, wherein the parameter c2 is in a range of 1.2≦c2≦1.5.

9. A gloss evaluation device to evaluate gloss level based on a specular gloss level of an object, the gloss evaluation device comprising:
a gloss meter to measure 20-degree specular gloss and 60-degree specular gloss;
a storage device to store the 20-degree specular gloss and the 60-degree specular gloss measured by the gloss meter; and
a processor to calculate a gloss rating and an image clarity rating using the 20-degree specular gloss and the 60-degree specular gloss stored in the storage device,
wherein the gloss rating is calculated by a function that uses a ratio between the 20-degree specular gloss and the 60-degree specular gloss as a variable and draws a saturation curve, and
the image clarity rating is calculated by a quadric or higher dimensional function that uses, as a variable, a difference calculated by deducting a weighted 60-degree specular gloss from a weighted 20-degree specular gloss.
